(19) United States
(12) Patent Application Publication
(10) Pub. No.: US 2017/0152905 A1
(43) Pub. Date: Jun. 1, 2017

(54) Brake Pad of a Disc Brake

(71) Applicant: KNORR-BREMSE Systeme fuer Nutzfahrzeuge GmbH, Muenchen (DE)

(72) Inventor: Dirk DRESEN, Leverkusen (DE)

(21) Appl. No.: 15/431,198

(22) Filed: Feb. 13, 2017

Related U.S. Application Data
(63) Continuation of application No. PCT/EP2015/066097, filed on Jul. 15, 2015.

(30) Foreign Application Priority Data
Aug. 13, 2014 (DE) 10 2014 111 548.1

(51) Int. Cl. F16D 69/04; F16D 65/092

(52) U.S. Cl. CPC F16D 69/0408; F16D 65/092; F16D 2069/005

(57) ABSTRACT

A brake pad of a disc brake, having a pad carrier plate and an intermediate layer which is fastened to the bottom surface thereof and carries an abrasive friction lining, is configured in such a way that the thickness of the unused friction lining is less than or equal to a predefined maximum wear dimension. The thickness of the friction lining plus part of the thickness of the intermediate layer correspond to the maximum wear dimension.

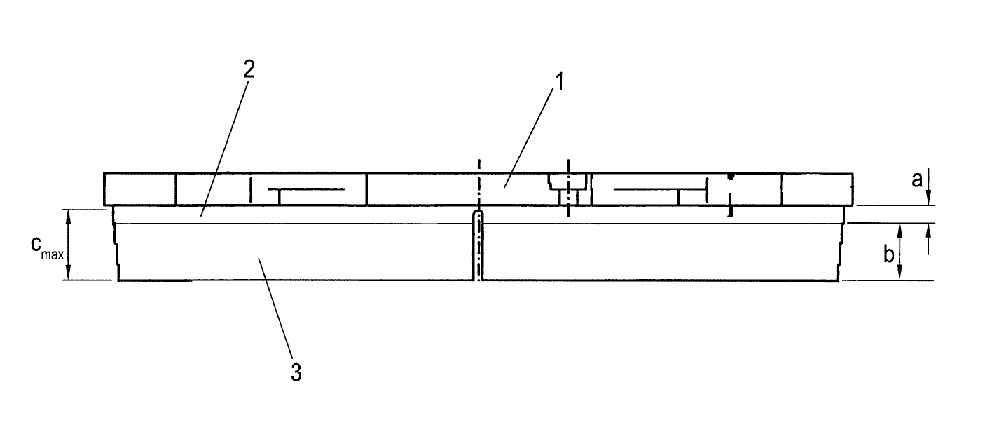

### CROSS REFERENCE TO RELATED APPLICATIONS

This application is a continuation of PCT International Application No. PCT/EP2015/066097, filed Jul. 15, 2015, which claims priority under 35 U.S.C. §119 from German Patent Application No. 10 2014 111 548.1, filed Aug. 13, 2014, the entire disclosures of which are herein expressly incorporated by reference.

### BACKGROUND AND SUMMARY OF THE INVENTION

The invention relates to brake pad of a disc brake with a pad carrier plate and an intermediate layer, which is fastened to the base area of the carrier plate and carries an abrasive friction lining.

Such brake pads are used in particular in the case of disc brakes that are fitted in commercial vehicles. Such a brake pad consists of a pad carrier plate, in particular metallic, either of cast iron or metal sheet, an intermediate layer fastened to the base area of the carrier plate and also an abrasive friction lining, which is held on the intermediate layer.

This intermediate layer serves primarily for reducing the transfer of heat and for damping vibrations occurring during braking that are synonymous with the generation of squealing noises, which is prevented by the intermediate layer.

The thickness of the friction lining has so far been determined by a prescribed maximum wear limit plus a safety allowance, which when reached requires that the brake pad as a whole be exchanged. In this case, a residual thickness of the friction lining remains attached to the intermediate layer, which is disposed of altogether, together with the remaining friction lining and the pad carrier plate.

Since, on account of the overall space available in the disc brake, specifically in the brake caliper and/or the brake carrier receiving the brake pads, the brake pad must not exceed a certain total thickness, while on the other hand, on account of the required flexural rigidity, the pad carrier plate likewise must not be less than a certain thickness, a relatively small dimension remains for the thickness of the intermediate layer. In the case of known brake pads, this is for example or usually about 2 mm, whereas the thickness of the friction lining is about 19 mm.

In order nevertheless to obtain adequate damping properties and/or insulating properties with a relatively small thickness of the intermediate layer, materials that are suitable for this purpose are used, but they are much more expensive than the material of the friction lining. This is contrary to the ongoing requirement to reduce costs, with the aim of cost optimization, this representing a particular problem to the extent that brake pads, in particular since they are wearing parts, are used in large numbers.

The invention is based on the object of further developing a brake pad of the generic type in such a way that it can be produced at lower cost and its suitability for use is improved.

This object is achieved by a brake pad with a pad carrier plate and an intermediate layer, which is fastened to the surface of the carrier plate and carries an abrasive friction lining. The thickness of the unused friction lining is less than or equal to a prescribed maximum wear limit. The thickness of the friction lining plus part of the thickness of the intermediate layer correspond to the maximum wear limit

The design of the brake pad according to the invention now makes it possible to dispense with the relatively expensive material of the intermediate layer and parts of the friction material. Instead, a material is used that is less costly but, because of the greater thickness, has damping properties that are at least similar to the intermediate layer previously used.

It is even contemplated to use a material of lower cost than the material of the friction lining as a new intermediate layer, for which recycled friction material mixed with abrasive friction particles and resins as a binder is suitable for example.

Since, according to the invention, the thickness of the unused friction lining is less than or equal to a prescribed maximum wear limit, after abrasive removal of the friction lining including the thickness of the safety allowance, the then likewise sufficiently friction-resistant intermediate layer comes into play, having friction properties that are comparable to those of the friction lining.

In principle, even after reaching the prescribed wear limit, the brake pad is still of the same thickness as the previous brake pad after abrasion of the friction lining determined by the wear limit, so that the residual thickness as it were of the brake pad is the same in both cases, that is to say the brake pad used until now and the new brake pad.

As mentioned, the intermediate layer may be produced from recycled friction material, so that extremely low-cost production of the intermediate layer is obtained, especially because, since the total thickness of the unused brake pad remains unchanged, the friction lining is correspondingly thinner.

Based on the dimensional example mentioned at the beginning in relation to the prior art, the intermediate layer is accordingly now >2 mm, while the friction lining is <19 mm, but added together are the same up to the pad carrier plate.

Apart from the not inconsiderable cost advantages that the invention offers, there is also a notable environmental benefit from reusing friction material for the purpose of producing an intermediate layer, since the remaining friction lining on a worn brake disc that was previously attached to the intermediate layer and disposed of is now, as it were, recycled.

Even after complete abrasion of the friction lining and after part of the thickness of the intermediate layer has likewise been removed by abrasion up to the maximum permissible wear limit, the remaining residual intermediate layer still attached to the carrier plate can likewise be reconditioned in a suitable way and processed once more into an intermediate layer, as long as this is in keeping with the requirements to be met.

As surprisingly found, what is more the tendency for the brake pad to develop cracks is significantly reduced, since the intermediate layer now has substantially the same properties in this respect as the friction lining.

Other objects, advantages and novel features of the present invention will become apparent from the following detailed description of one or more preferred embodiments when considered in conjunction with the accompanying drawing.

### BRIEF DESCRIPTION OF THE DRAWING

The single FIGURE shows an exemplary brake pad according to the invention in a plan view.

### DETAILED DESCRIPTION OF THE DRAWING

Represented in the FIGURE is a brake pad of a disc brake, with a pad carrier plate 1, which consists of metal or some other suitable material and may, for example, be formed from cast iron or metal sheet.

Fastened to the pad carrier plate 1, usually by adhesive bonding and/or interlocking engagement, is an intermediate layer 2, which carries an abrasive friction lining 3, which when in use, that is to say during braking, is in contact under applied pressure with a brake disc on the vehicle. In this case, the friction lining 3 is preferably connected to the intermediate layer by material bonding.

The brake pad shown is, as it were, a new product, i.e. the friction lining 3 is unused and is at its maximum thickness b. The thickness of the intermediate layer 2 is denoted by a.

According to the invention, the thickness b of the unused (new) friction lining 3 is smaller than a prescribed maximum wear limit cₘₐₓ. The thickness b of the friction lining 3 plus part of the thickness a of the intermediate layer 2 correspond to the maximum wear limit cₘₐₓ.

It is clearly evident that, before reaching the wear limit cₘₐₓ, the friction lining 3 is completely abraded, so that in the further course of braking operations part of the thickness a of the intermediate layer 2 is likewise abraded, until the maximum wear limit cₘₐₓ is reached.

The thickness b of the friction lining 3 in the unused (new) situation is preferably <19 mm, while the thickness a of the intermediate layer 2 is >2 mm. It goes without saying that other dimensions are also contemplated; as far as the total thickness of the brake pad is concerned, dependent on the overall space of the respective disc brake in which the brake pads are fitted.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A brake pad of a disc brake, comprising:
a pad carrier plate;
an intermediate layer fastened to a surface of the pad carrier plate; and
an abrasive friction lining carried by the intermediate layer, wherein
a thickness of the abrasive friction lining before being used is less than or equal to a prescribed maximum wear limit, and
the thickness of the friction lining before being used plus a portion of the thickness of the intermediate layer correspond to the prescribed maximum wear limit.

2. The brake pad as claimed in claim 1, wherein the intermediate layer comprises at least a proportion of recycled friction material.

3. The brake pad as claimed in claim 2, wherein the intermediate layer comprises friction particles bonded with synthetic resin.

4. The brake pad as claimed in claim 1, wherein the intermediate layer comprises friction particles bonded with synthetic resin.

5. The brake pad as claimed in claim 1, wherein the intermediate layer is connected to the pad carrier plate and/or the friction lining by material bonding and/or interlocking engagement.

6. The brake pad as claimed in claim 1, wherein the thickness of the intermediate layer is >2 mm.

7. The brake pad as claimed in claim 6, wherein the thickness of the friction lining before being used is <19 mm.

8. The brake pad as claimed in claim 1, wherein the thickness of the friction lining before being used is <19 mm.
